(19) United States
(12) Patent Application Publication
(10) Pub. No.: US 2016/0241794 A1
(43) Pub. Date: Aug. 18, 2016

(54) HELMET FOR SHOOTING MULTI-ANGLE IMAGE AND SHOOTING METHOD

(71) Applicant: MOBRICK CO, LTD, Chungcheongbuk-do (KR)

(72) Inventors: Dong Che LEE, Chungcheongbuk-do (KR); Soo Geun YOO, Chungcheongbuk-do (KR)

(21) Appl. No.: 15/025,430

(22) PCT Filed: Mar. 6, 2014
(86) PCT No.: PCT/KR2014/001856

§ 371 Date: Mar. 28, 2016

(30) Foreign Application Priority Data
Sep. 26, 2013 (KR) 10-2013-0114740

(51) Int. Cl. H04N 5/247; H04N 5/77; H04N 5/225

(52) U.S. Cl. CPC H04N 5/247; H04N 5/2251; H04N 5/772

(57) ABSTRACT

The present invention relates to a helmet for recording a multi-angle video and a method of recording the multi-angle video by the helmet. The helmet includes a helmet unit including at least one camera mounting unit, a camera unit configured to be mounted on the camera mounting unit and configured to record a video of outside, an encoding unit configured to encode the video recorded by the camera unit, a communication unit configured to transmit device information of the helmet and to receive, when the helmet is determined to belong to a predetermined recording group at the server, synchronization information and a control signal transmitted, a synchronizing unit configured to perform a marking according to a predetermined period based on the synchronization information and to generate marking information, and a transmitting unit configured to transmit the encoded video and the marking information to the server via the communication unit.

### TECHNICAL FIELD

The present invention relates to a digital broadcasting service, and more particularly, to a service for providing a multi-angle video in which the multi-angle video is recorded by a helmet for recording the multi-angle video and a synchronization of the recorded video is performed.

### BACKGROUND ART

In recent years, with growth of high-speed communication network and broadcasting and communication fusion technology, an IPTV has become one of the main fields in the broadcasting and communication industry in which a user can selectively receive desired contents via the high-speed communication network.

When broadcasting a program in which many people are participating, such as sports broadcasting and game broadcasting, the audience often wants to watch his or her favorite player in a focused manner; however, the conventional television broadcasting service provides an edited screen selected by a broadcasting company through a single channel.

To cope with this, a multi-angle broadcasting service has been launched in which a plurality of cameras is disposed in a realtime event (e.g., sports game, arena, and the like), and videos recorded by cameras of different angles are transmitted through different channels. A user can watch a video of his or her favorite angle by changing the channel.

However, because the conventional multi-angle service only enables the audience to watch videos provided by a broadcasting station by editing them to fit a TV screen, it is hard to watch pictures outside the TV screen. Further, when many people watch a TV together, because everyone has different angles to watch, if one selects a specific camera angle, the others are interrupted to watch the TV.

In addition, when the multi-angle service is provided by way of a terminal other than the TV, because videos provided to the TV and the other terminal are separately transmitted, there may be a delay between different videos depending on conditions of an IPTV service and a network, and hence, when the users watch the videos in the same place, there may be a problem of synchronization.

In particular, when the multi-angle service is provided to a plurality of terminals each having a mobile camera (e.g., a mobile phone, a mobile broadcasting equipment, and the like), event videos at the same time window can hardly be watched at the same time due to the performance of a recording terminal and a difference in communication speed when uploading the videos. To cope with these problems, synchronization is needed for the multi-angle recording devices in an artificial or mechanical manner.

### DISCLOSURE OF INVENTION

### Problem to be Solved by the Invention

It is an object of the present invention to provide an optimum watching environment to users, when the same event is recorded by a plurality of terminals and broadcast on terminals, by allowing a synchronization of the videos to be smoothly achieved.

### Means for Solving Problem

A helmet for recording a multi-angle video, according to some embodiments of the present invention, includes a helmet unit including at least one camera mounting unit, a camera unit configured to be mounted on the camera mounting unit and configured to record a video of outside, an encoding unit configured to encode the video recorded by the camera unit, a communication unit configured to transmit device information of the helmet to a server and to receive synchronization information and a control signal transmitted from the server when the helmet is determined to belong to a predetermined recording group, a synchronizing unit configured to perform a marking according to a predetermined period based on the synchronization information and to generate marking information, and a transmitting unit configured to transmit the encoded video and the marking information to the server via the communication unit.

A method of recording a multi-angle video by a helmet for recording the multi-angle video, according to some embodiments of the present invention, includes transmitting, by each of a plurality of helmets for recording videos of different angles at different locations from each other, device information to a server, determining, by the server, whether or not each of the helmets belongs to a predetermined recording group based on the device information, transmitting, by the server, synchronization information and a control signal to a helmet that is determined to belong to the recording group, recording, by each of the helmets, a video of outside, encoding, by each of the helmets, the video into a digital video, generating, by each of the helmets, marking information by performing a marking on the video according to a predetermined period based on the synchronization information, and transmitting, by each of the helmets, the encoded video and the marking information to the server.

### Effect of the Invention

According to some embodiments of the present invention, when a user watches a multi-angle video, the multi-angle pictures are synchronized to provide the user with pictures of the same time window.

Therefore, the multi-angle pictures can be stably provided to the user, and hence the user's interest and convenience can be improved and the usage of the multi-angle service can be promoted.

### BRIEF DESCRIPTION OF DRAWINGS

FIG. 1 is a schematic diagram of a system for providing a multi-angle video service according to some embodiments of the present invention.

FIG. 2 is a perspective view of a helmet for recording a multi-angle video according to some embodiments of the present invention.

FIG. 3 is a flowchart showing a method of recording a multi-angle video according to some embodiments of the present invention.

FIG. 4 is a block diagram of the helmet for recording a multi-angle video according to some embodiments of the present invention.

FIG. 5 is a flowchart showing a step of providing a multi-angle video service in the system for providing a multi-angle video service according to some embodiments of the present invention.

FIG. 6 is a block diagram of a server according to some embodiments of the present invention.

FIG. 7 is a schematic diagram for illustrating a communication process between the helmet for recording a multi-angle video and the server according to some embodiments of the present invention.

FIG. 8 is a schematic diagram for illustrating a communication process between the helmet for recording a multi-angle video and the server according to some embodiments of the present invention.

FIG. 9 is a schematic diagram of a screen for selecting a helmet for recording a multi-angle video according to some embodiments of the present invention.

### BEST MODE(S) FOR CARRYING OUT THE INVENTION

Hereinafter, at least one embodiment of the present invention will be described in detail with reference to the accompanying drawings. In the following description, like reference numerals designate like elements, although the elements are shown in different drawings. In the following description, usage of suffixes such as ‘device’ or ‘unit’ used for referring to elements is given merely to facilitate explanation of the present invention, without having; any significant meaning by itself. The ‘device’ and ‘unit’ can be used in a mixed manner, and can be designed based on hardware or software.

Further, the accompanying drawings of the present invention aim to facilitate understanding of the present invention and should not be construed as limited to the accompanying drawings.

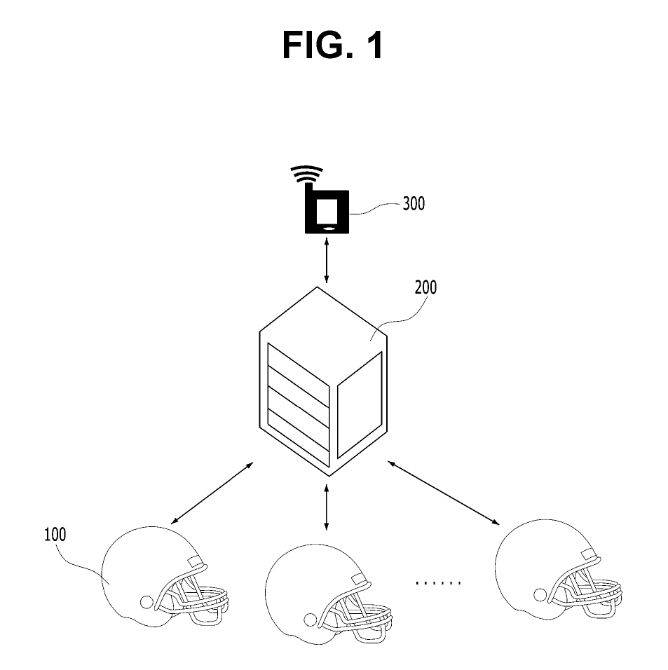

FIG. 1 is a schematic diagram of a system for providing a multi-angle video service according to some embodiments of the present invention.

In some embodiments, a plurality of multi-angle video recording helmets 100 is connected to a server 200 to perform an operation for providing a multi-angle video. That is, each of the multi-angle video recording helmets records the same event video at a different location and sends the recorded video to the server, and the server transmits a multi-angle video including the video recorded by the multi-angle video recording helmets to a user terminal 300 of a subscriber, thus performing a multi-angle video providing service. The server 200 shown in drawings including FIG. 1 is a sync server, which differs from a streaming server for broadcasting.

For example, when providing a football game through the multi-angle video providing service, a plurality of football players wears the multi-angle video recording helmets 100, the server 200 receives the videos from the respective multi-angle video recording helmets 100 to generates a multi-angle video, and the generated multi-angle video is displayed on the user terminal 300, allowing the user to enjoy the game from the point of view of each player.

In some embodiments, each of the multi-angle video recording helmets 100 includes a device that can record a video while moving, such as an action cam, a smartphone equipped with a camera, a digital camera, and the like. That is, the present disclosure describes the multi-angle video recording helmet as an exemplary embodiment. According to various embodiments, a case where a device other than the multi-angle video recording helmet performs the role of the multi-angle video recording helmet is included in the scope of the present invention.

In some embodiments, the user terminal 300 includes various devices that can display a picture and perform data transmission and reception, such as a tablet PC, a laptop PC, and the like.

Configurations of the multi-angle video recording helmet 100, the server 200, the user terminal, and a method of providing the multi-angle video service based on a multi-angle video service providing server including these units are described in detail below.

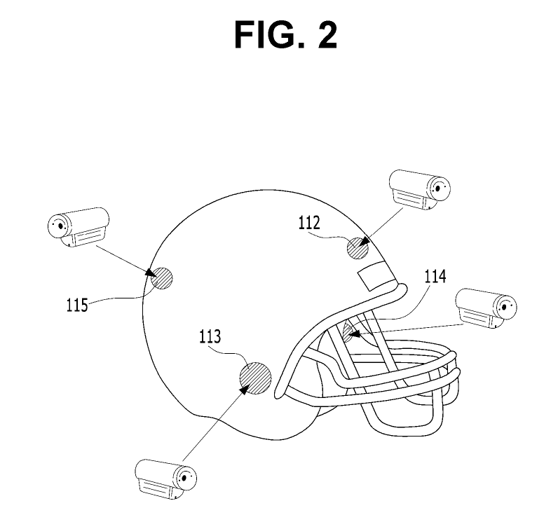

FIG. 2 is a perspective view of a helmet for recording a multi-angle video according to some embodiments of the present invention.

In some embodiments, the multi-angle video recording helmet has an external structure shown in FIG. 2. That is, the multi-angle video recording helmet includes a helmet unit including at least one camera mounting unit as an external shape.

In some embodiments, the helmet unit includes first to fourth camera mounting units 112 to 115, on which a first camera mounted on the front side, a second camera mounted on the right side, a third camera mounted on the left side, and a fourth camera mounted on the rear side are mounted, respectively. Therefore, the multi-angle video recording helmet can not only record a video by using only one camera, but also record front, right, left, and rear videos at the same time by using the four cameras.

In some embodiments, at least one of the first to fourth camera mounting units 112 to 115 is a 3-dimensional (3D) camera for three-dimensionally displaying a recorded video. That is, a 3D video recording camera can be mounted to provide a more realistic picture.

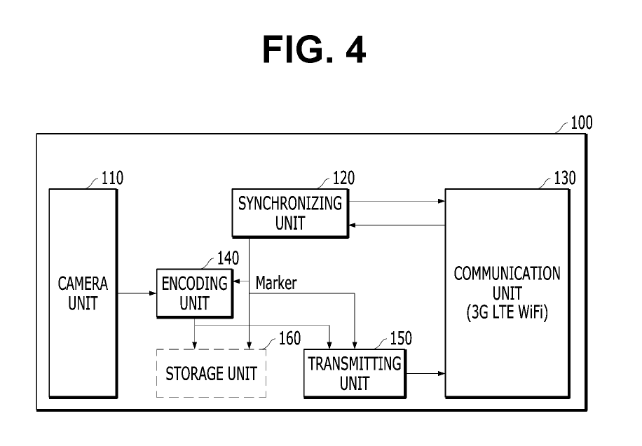

In some embodiments, each of the first to fourth camera mounting units 112 to 115 only includes a camera unit 110 (see FIG. 4), while the other elements are collectively included in a different area of the helmet unit. That is, even when the plurality of cameras is mounted, only the necessary camera units for recording the videos are mounted and the other elements including an encoding unit, a storage unit, a synchronizing unit, a transmitting unit, a communication unit, and a battery unit are each provided as one unit and located at a location with the least impact among arbitrary locations of the helmet, which are shared by the plurality of camera units.

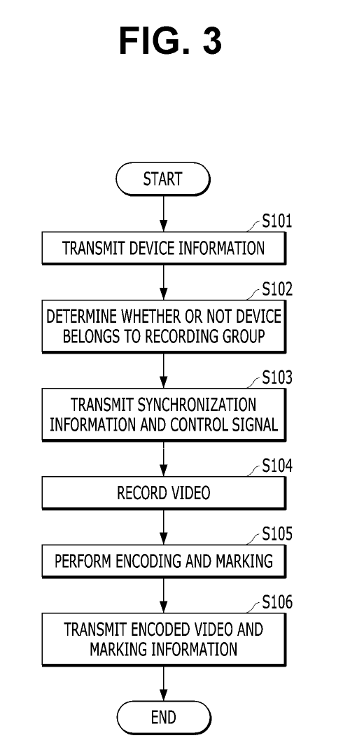

FIG. 3 is a flowchart showing a method of recording a multi-angle video according to some embodiments of the present invention.

In some embodiments, the multi-angle video can be provided by way of the steps shown in FIG. 3. These steps can be performed by using a multi-angle video recording helmet having a structure shown in FIG. 4.

Firstly, each of a plurality of multi-angle video recording helmets respectively recording videos of different angles transmits its own device information to the server (Step S101).

In some embodiments, in order to acquire recording videos of different angles, the plurality of multi-angle video recording helmets is used for recording the videos, and in order to generate a multi-angle video by using the multi-angle video recording helmet, the device information of the multi-angle video recording helmets are transmitted to the server.

In some embodiments, as a means for transmitting the information, a mobile communication network is used. That is, a 3G communication network or an LTE communication network is used, and to this end, the multi-angle video recording helmet needs to sign on a mobile communication network. Further, in some embodiments, when a Wifi communication is available, the information can be transmitted to the server via the Wifi communication. In other words, the communication means does not matter, so long as data can be exchanged between the server and the multi-angle video recording helmets. Therefore, various types of communication formats other than the above-mentioned can be used for exchanging data.

Subsequently, the server determines whether or not each of the multi-angle video recording helmets belongs to a predetermined recording group based on the device information (Step S102).

In some embodiments, upon receiving the device information, the server can determine which multi-angle video recording helmet belongs to which recording group. The recording group includes, for example, “Team A” group, and in this case, all multi-angle video recording helmet mounted on helmets of players of the team A are included in the recording group.

In some embodiments, at Step S102, when the device information of the multi-angle video recording helmet indicates that it is registered to the same group name (e.g., Group A) in the server, the server determines that the multi-angle video recording helmet is included in the recording group. That is, for example, the server includes a group information table that contains information items of target multi-angle video recording helmets.

In some embodiments, when there is a discrepancy between the device information received from the multi-angle video recording helmet and the device information stored in the server, the server updates the stored information of the multi-angle video recording helmet. In other words, the server maintains the information of the multi-angle video recording helmet in the latest state.

In some embodiments, when the information of the multi-angle video recording helmet is not registered as the same group name, the server determines that the multi-angle video recording helmet is not included in the recording group. In this case, the server generates a new group for the multi-angle video recording helmet that is determined not to belong to the recording group based on the device information of the multi-angle video recording helmet, and sets the multi-angle video recording helmet as a master recording device. That is, a new recording group is generated centering around the multi-angle video recording helmet that does not belong to the recording group. Further, the server can generate a group table for the generated group and store information on the synchronization period among the information on the master recording device in the group table. In this manner, the new group is generated, and the information on the new group is stored in the server and utilized.

In some embodiments, when a group information request signal is transmitted to the server from another (second) multi-angle video recording helmet that does not belong to the recording group, the server transmits information an existing group to the multi-angle video recording helmet that has transmitted the request signal. That is, the multi-angle video recording helmet that has no set recording group can request for the information on the existing group in the entire group information or a field of interest (defined classification) to the server, and transmit a sign-on request signal to the server based on the received information. When the sign-on request signal is received, the server transmits a sign-on permission/denial signal for determining whether or not to permit a sign-on of the second multi-angle video recording helmet to the master recording device. In response to this, the master recording device determines whether to permit the sign-on, and transmits a sign-on permission signal or a sign-on denial signal to the server.

In some embodiments, when the sign-on request signal is transmitted, the master recording device displays a related menu on the display unit, receives a signal for permitting or denying a sign-on from the user via the user interface unit, and generates and transmits the sign-on permission signal or the sign-on denial signal.

In some embodiments, in a state in which the master mode is turned on in any one multi-angle video recording helmet and turned off in the other multi-angle video recording helmet among the plurality of multi-angle video recording helmet, when the sign-on request signal is transmitted, the sign-on permission signal is automatically generated and transmitted.

When the sign-on permission signal for the multi-angle video recording helmet is received from the master recording device, the server configures a recording group by including the multi-angle video recording helmet that has transmitted the sign-on request signal in the generated group as a slave recording device, and manages the recording group. Therefore, the digital videos recorded by the master recording device and the slave recording device can be marked based on the marking period reference of the generated group in the master recording device and the slave recording device, respectively. Accordingly, the synchronization can be performed based on the marking information.

In some embodiments, upon receiving a synchronization completion signal from the master recording device, the server transmits the synchronization completion signal to each slave recording device to stop the synchronization operation.

Subsequently, when the multi-angle video recording helmet is determined to belong to the recording group, the server transmits the synchronization information and the control signal to the multi-angle video recording helmet (Step S103).

In some embodiments, when transmitting the synchronization information and the control signal, the server transmits, to the multi-angle video recording helmet that is determined to belong to the recording group, the synchronization information including at least one of synchronization period information (e.g., marking with 5-second intervals) or marking existence determination information and the control signal including at least one of recording instruction information (e.g., recording start/stop/end signal) or recording information (information on number of frames per second, color, and size). In some embodiments, the marking existence determination information includes information on whether to directly perform a marking on the video recorded by the multi-angle video recording helmet or to store as separate marking information.

In some embodiments, the process performed by the server at the step of transmitting the synchronization information and the control signal includes transmitting the synchronization period information to the multi-angle video recording helmets that are determined to belong to the recording group, determining whether or not the multi-angle video recording helmet to which the synchronization period information has been transmitted are ready for recording, transmitting, when the multi-angle video recording helmet are ready for recording, a recording start signal to the multi-angle video recording helmet, and receiving an acknowledgement (ACK) signal from the multi-angle video recording helmets. In other words, the sever can control the start of recording.

Subsequently, a video of outside is recorded through the multi-angle video recording helmet (Step S104). The video recorded by the multi-angle video recording helmet is encoded into a digital video, and marking information is generated by performing a marking on the recorded video based on the synchronization information (Step S105). The multi-angle video recording helmet transmits the encoded video and the marking information to the server (Step S106).

In some embodiments, the marking is performed on the encoded video or the encoding is performed after performing the marking. In this case, information on this order is included in the video, such that the information is extracted at a decoder of the user terminal.

In some embodiments, when performing the marking, the multi-angle video recording helmet performs the marking on the recorded video according to a predetermined period based on the synchronization information received from the server. Further, in some embodiments, the multi-angle video recording helmet transmits the marking information to the server according to a predetermined period based on the information received from the server.

In some embodiments, when performing the marking, the multi-angle video recording helmet stores therein the marking information by including the marking information as dummy data, for example, in the form of information on the order of synchronization, information on time, or information on the video image, in the video material, and transmits the marking information to the server.

In some embodiments, when performing the marking, the multi-angle video recording helmet stores the marking information in the storage unit of the multi-angle video recording helmet according to a predetermined period based on the information received from the server, and when the encoding is completed, transmits the encoded video and the marking information stored until the completion of the encoding to the server.

In some embodiments, the marking information is transmitted to the server when the marking is completed, and in some embodiments, the marking information is transmitted to the server when a certain amount of marking information is accumulated.

With the above-mentioned steps, the server receives the encoded video and the marking information from each of the multi-angle video recording helmets, and provides a multi-angle video service by providing the received data to the user. As the times of playing the recorded videos can be synchronized by using the encoded videos and the marking information, the user can be provided with the multi-angle video through a video player in the streaming server or the user terminal in a smooth manner.

FIG. 4 is a block diagram of the helmet for recording a multi-angle video according to some embodiments of the present invention.

In some embodiments, as shown in FIG. 2, the multi-angle video recording helmet 100 includes a helmet unit (not shown) including at least one camera mounting unit as an external constituent element and a camera unit 110, a synchronizing unit 120, a communication unit 130, an encoding unit 140, a transmitting unit 150, and a storage unit 160 as internal constituent elements. Further, in order to provide power to each of the above modules, the multi-angle video recording helmet 100 includes a battery unit (now shown). Each of the above-mentioned elements can be configured as a module/unit based on hardware. One module/unit can be configured to perform a function of other module/unit. That is, the modules/units can be configured in an integral or detailed manner according to necessity or purpose.

Although the camera unit 110, the synchronizing unit 120, the communication unit 130, the encoding unit 140, the transmitting unit 150, and the storage unit 160 are arranged in a single block in FIG. 4, this is merely to ease the description of each of the constituent elements. In some embodiments, only the camera unit 110 is arranged being exposed to the outside of the helmet unit to record the video, and the rest of the units including the synchronizing unit 120, the communication unit 130, the encoding unit 140, the transmitting unit 150, the storage unit 160, and the battery unit (not shown) are arranged at arbitrary locations in the helmet with less impact.

In other words, although the camera unit 110 can be configured in an integrated manner including therein the circuit units 120, 130, 140, 150, and 160 and the battery unit and mounted on or embedded in the helmet like a typical action camera, it is preferred that only a camera lens of the camera unit 110 be exposed to outside or molded to protrude and the rest portion of the camera unit 110 and whole or a part of the circuit units 120, 130, 140, 150, and 160 be embedded or built in the helmet.

The camera unit 110 is configured to record a video of outside. In some embodiments, aperture and shutter speed can be automatically adjusted depending on brightness of the outside or moving speed of an object.

The synchronizing unit 120 generates marking information by performing a marking based on the synchronization information received from the server. Examples related to the marking are similar to the above contents described with reference to FIG. 2.

The synchronization information is information for allowing a synchronization of the multi-angle video recording helmets that record videos of different angles at different locations from each other by way of marking in a predetermined period.

In some embodiments, the synchronizing unit 120 performs a marking on the recorded video in a predetermined period based on the synchronization information received from the server by the multi-angle video recording helmet.

In some embodiments, a streaming server waits until arriving at a synchronization time for a plurality of broadcasting video materials based on the synchronization information, and after removing the marking information, transmits the synchronized video to the user terminal (function A). When a network condition is poor, the function A can be performed by a movie player in the user terminal. In this case, because the video material may be paused for a predetermined time or longer during a time required for the synchronization, for such a standby time, a specific image (e.g., an advertisement image) can be displayed on the user terminal.

The communication unit 130 transmits the device information of the multi-angle video recording helmet to the server, and when the server determines that the multi-angle video recording helmet belongs to a predetermined recording group, receives the synchronization information and the control signal from the server. In some embodiments, a transmission means using the communication unit includes a mobile communication network such as a 3G communication network or an LTE communication network. To this end, the multi-angle video recording helmet needs to sign on the mobile communication network. Further, in some embodiments, the information can be transmitted by using a Wifi communication in an area where the Wifi communication is available. In other words, no matter what the communication means is used, various types of communication format can be used so long as the data can be exchanged between the server and the multi-angle video recording helmet.

The synchronization information includes at least one of synchronization period information or marking existence determination information, and the control signal includes at least one of recording instruction information or recording information.

The encoding unit 140 encodes the video recorded by the camera unit. When encoding the video, various encoding formats based on MPEG standard can be used, and even video formats standards other than the MPEG can also be used according to device setting of the multi-angle video recording helmet. Further, the encoding can be performed by receiving a selection of an encoding format from the user.

The transmitting unit 150 transmits the encoded video and the marking information encoded and performed by the multi-angle video recording helmet to the server via the communication unit.

The storage unit 160 stores therein the encoded video and the marking information. In some embodiments, the communication unit 130 transmits the encoded video and the marking information stored in the storage unit. The storage unit includes various recording means such as RAM, SSD, HDD, and the like.

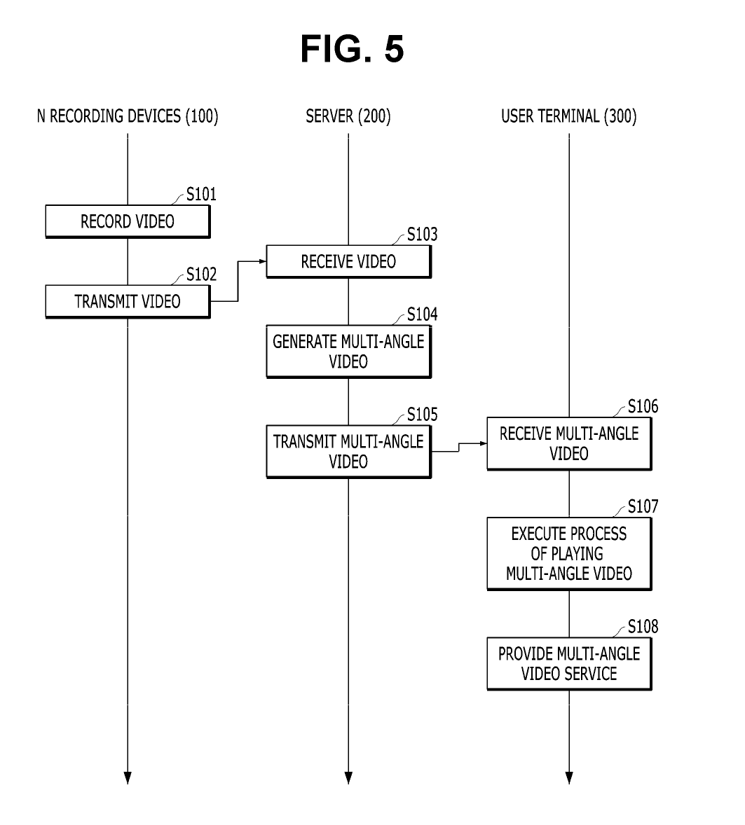

FIG. 5 is a flowchart showing a step of providing a multi-angle video service in the system for providing a multi-angle video service according to some embodiments of the present invention.

In some embodiments, the method of providing the multi-angle video service by using the multi-angle video service providing system is performed through the steps shown in FIG. 5.

Firstly, each of a plurality of multi-angle video recording helmets that record videos of different angles at different locations from each other, i.e., a plurality of recording devices, records a video (Step S101).

In some embodiments, each of the recording devices records the video by including information for determining an angle of the video including the location information of the recording device in the recorded video.

Subsequently, each of the recording devices transmits the recorded video to the server (Step S102).

In some embodiments, a mobile communication network is used as the transmission means. In other words, a 3G communication network or an LTE communication network can be used, and to this end, the recording devices need to sign on the mobile communication network. Further, in some embodiments, the recorded videos are transmitted to the server via a Wifi communication where the Wifi communication is available. That is, no matter what the communication means is used, various types of communication formats can be used so long as the data can be exchanged between the server and the recording device. Such flexibility in using various communication formats applies in the same manner to a communication between the server 200 and the user terminal 300.

Subsequently, the server receives the recorded videos (Step S103), and generates a multi-angle video based on the received videos (Step S104).

In some embodiments, when generating the multi-angle video, various video formats can be used, such as AVI, MKV, MOV, and the like. Further, in order to prevent a device other than the subscriber from importing the data, the multi-angle video can be generated by using an encryption.

Subsequently, the server transmits the generated multi-angle video to the user terminal (Step S105). In some embodiments, subscriber information of the multi-angle video service is stored in the server, and the multi-angle video is transmitted to one or more user terminals 300 based on the subscriber information.

Subsequently, the user terminal receives the multi-angle video (Step S106), and executes a process for playing the received multi-angle video (Step S107). In some embodiments, when the process is not pre-installed in the user terminal, an installation screen is displayed to allow the user to install the process in the user terminal.

Subsequently, the received multi-angle video is displayed through the process (Step S108).

That is, the multi-angle video service is provided to the user through the above-mentioned steps.

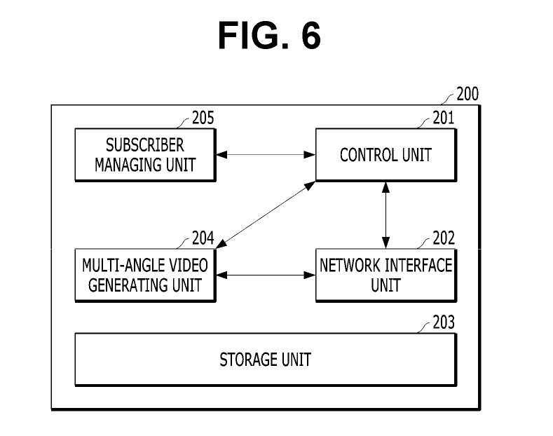

FIG. 6 is a block diagram of a server according to some embodiments of the present invention.

In some embodiments, the server 200 includes a control unit 201, a network interface unit 202, a storage unit 203, a multi-angle video generating unit 204, and a subscriber managing unit 205.

The control unit 201 controls an operation of each module of the server.

The network interface unit 202 is configured to exchange data with the multi-angle video recording helmet 100 and the user terminal 300.

In some embodiments, as a means for transmitting the information, a mobile communication network is used. That is, a 3G communication network or an LTE communication network is used, and to this end, the multi-angle video recording helmet needs to sign on a mobile communication network. Further, in some embodiments, when a Wifi communication is available, the information can be transmitted to the server via the Wifi communication. In other words, the communication means does not matter, so long as data can be exchanged between the server and the multi-angle video recording helmets. Therefore, various types of communication formats other than the above-mentioned can be used for exchanging data.

The storage unit stores therein the video received from the multi-angle video recording helmet 100 or multi-angle video to be transmitted to the user terminal 300.

The multi-angle video generating unit 204 generates and re-encodes the multi-angle video based on the videos stored in the storage unit 203. In some embodiments, various encoding formats based on MPEG standard can be used, and even video formats standards other than the MPEG can also be used according to device setting of the multi-angle video recording helmet. Further, the encoding can be performed by receiving a selection of an encoding format from the user.

The subscriber managing unit 205 manages the recording group of the multi-angle video recording helmets 100, and manages the data transmission and reception with respect to the user terminal 300. That is, the multi-angle video service may not be provided to a non-subscriber, and if a subscription is expired, the multi-angle video service may not be provided even to a subscriber.

With this configuration, the server 200 receives the recorded videos, generates a multi-angle video based on the received videos, and transmits the generated multi-angle video to the user terminal.

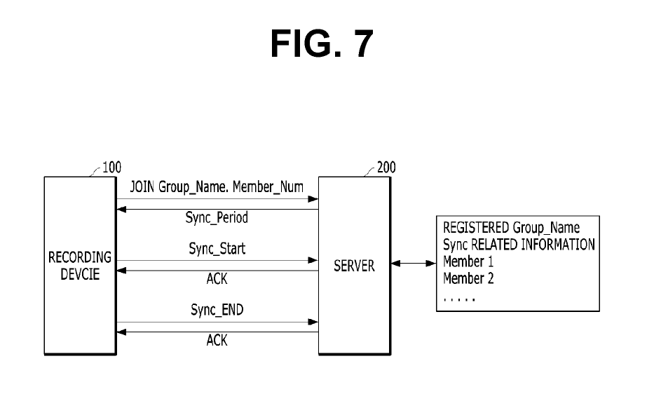

FIG. 7 is a schematic diagram for illustrating a communication process between the helmet for recording a multi-angle video and the server according to some embodiments of the present invention.

In some embodiments, upon determining that the device information of the multi-angle video recording helmet is registered as the same group name in the server, the mutual communication is performed as shown in FIG. 7.

Firstly, the multi-angle video recording helmet 100 transmits a join request instruction to join a recording group and group name information to the server 200 (JOIN Group_Name and Member_Num).

Subsequently, the server 200 reviews the device information of the multi-angle video recording helmet 100 included in the registered recording group, and when there is a discrepancy, updates and stores the information of the multi-angle video recording helmet stored in the server, and then transmits the synchronization period (Sync_Period) information to the recording device 100.

Subsequently, upon determining that the multi-angle video recording helmets are ready for recording (artificial determination or detection of completion of member configuration), the server 200 transmits a recording start (Sync_Start) instruction to the multi-angle video recording helmets. The server 200 then receives an acknowledgement (Ack) instruction in response to the recording start signal from the recording device.

With this operation, the multi-angle video recording helmet can start recording, and the marking is performed according to the period (e.g., 5 seconds) based on the synchronization period information. In this case, when the value of the synchronization period is zero, the multi-angle video recording helmets start the recording simultaneously without the marking information or generate the marking information only once at the time of starting the recording.

Subsequently, when it is determined that it is the time to end the recording synchronization based on artificial or system determination, the server 200 transmits recording end (Sync_END) instruction to the multi-angle video recording helmet 100 to instruct ending the recording and the marking of the multi-angle video recording helmet 100.

In some embodiments, even in the middle of the recording, when a join request instruction for a new recording device is received, the synchronization is performed through the above-mentioned steps.

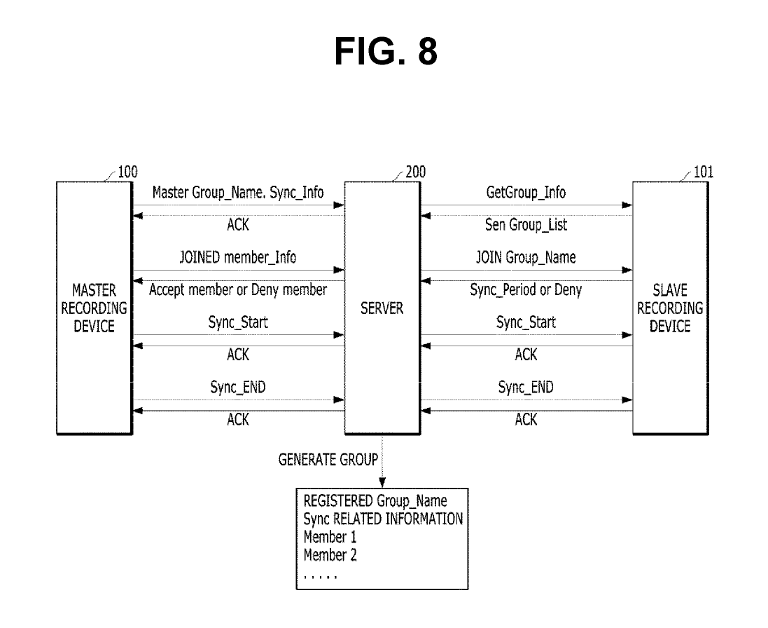

FIG. 8 is a schematic diagram for illustrating a communication process between the helmet for recording a multi-angle video and the server according to some embodiments of the present invention.

In some embodiments, when it is determined that the information of the multi-angle video recording helmet is not registered as the same group name in the server, a mutual communication shown in FIG. 8 is performed.

Firstly, the multi-angle video recording helmet 100 transmits an instruction (Master Group_Name and Sync_Info) to the server 200 to generate a recording group with the multi-angle video recording helmet as a master recording device. The instruction includes information of the master recording device and synchronization information including the synchronization period information.

Subsequently, upon receiving the instruction, the server 200 generates a new recording group.

Further, another (second) multi-angle video recording helmet 101 can transmit a group information request signal (Get Group_Info) for selecting a group for recording synchronization to the server 200.

In response, the server 200 transmits information including a group name to the multi-angle video recording helmet 101.

Moreover, the multi-angle video recording helmet 101 transmits a join request signal (JOIN Group_Name) to join a specific recording group to the server.

In response, the server 200 transmits a sign-on permission/denial signal (JOINED Member_Info) for the multi-angle video recording helmet 101 to the master recording device, to allow the master recording device to determine whether to permit the sign-on to the recording group.

Subsequently, the master recording device determines whether to permit the sign-on of the multi-angle video recording helmet 101. Upon determining whether to permit the sign-on based on predetermined criteria, the master recording device transmits a sign-on permission signal or a sign-on denial signal to the server 200. Upon signing on, the multi-angle video recording helmet 101 is included in the recording group as a slave recording device.

Further, upon determining that a formation of the recording group is completed at a specific time, the master recording device notifies the recording start (Sync_Start) signal to the multi-angle video recording helmet 101 via the server 200, and when the master recording device 100 wants to end the recording synchronization, the master recording device transmits the recording end (Sync_End) instruction to the multi-angle video recording helmet 101 via the server 200, to end the recording synchronization. On the other hand, when a new multi-angle video recording helmet is connected while the synchronized group performs a synchronized recording, the recording group can be configured through the above-mentioned steps.

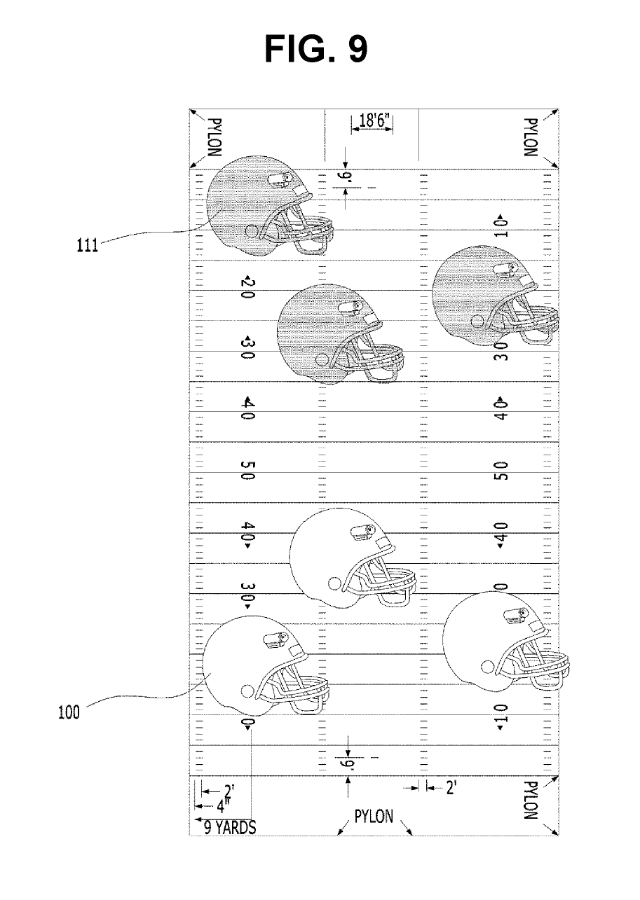

FIG. 9 is a schematic diagram of a screen for selecting a helmet for recording a multi-angle video according to some embodiments of the present invention.

In some embodiments, a plurality of multi-angle video recording helmets can record videos simultaneously in a single event, and hence the user can select a specific multi-angle video recording helmet to watch a video of a desired angle. To this end, various types of video select menu can be provided.

In FIG. 9, in a multi-angle video service for a football game, a football stadium is displayed, and locations of the multi-angle video recording helmets on each of which the camera is mounted are displayed by overlaying the displayed football stadium. Therefore, the user can find the locations of the multi-angle video recording helmets and select a video of a desired angle, and hence the multi-angle video service can be provided more effectively. To this end, the multi-angle video recording helmets transmit their location information to the server in a constant manner, by which the locations of the multi-angle video recording helmets are monitored and provided to the user.

In some embodiments, the multi-angle video recording helmets 100 that belong to the first recording group and the multi-angle video recording helmets 101 that belong to the second recording group are displayed in different colors on the select screen to allow the user to facilitate the selection of the multi-angle video recording helmet.

Although exemplary embodiments of the present invention have been described for illustrative purposes, those skilled in the art will appreciate that various modifications, additions and substitutions are possible, without departing from the idea and scope of the claimed invention. Accordingly, one of ordinary skill would understand the scope of the claimed invention is not to be limited by the explicitly described above embodiments but by the claims and equivalents thereof.

1. A helmet for recording a multi-angle video, comprising:
a helmet unit including at least one camera mounting unit;
a camera unit configured to be mounted on the camera mounting unit and configured to record a video of outside;
an encoding unit configured to encode the video recorded by the camera unit;
a communication unit configured to transmit device information of the helmet to a server and to receive synchronization information and a control signal transmitted from the server when the helmet is determined to belong to a predetermined recording group;
a synchronizing unit configured to perform a marking according to a predetermined period based on the synchronization information and to generate marking information; and
a transmitting unit configured to transmit the encoded video and the marking information to the server via the communication unit.

2. The helmet according to claim 1, wherein the communication unit is configured to receive the synchronization signal that allows a synchronization to be performed with a plurality of helmets configured to record videos of different angles at different locations from each other.

3. The helmet according to claim 2, wherein
the synchronization information includes at least one of synchronization period information or marking status determination information, and
the control signal includes at least one of recording instruction information or recording information.

4. The helmet according to claim 1, further comprising:
a storage unit configured to store the encoded video and marking information, and
the communication unit is configured to transmit the encoded video and the marking information stored in the storage unit to the server.

5. The helmet according to claim 1, wherein the camera unit includes
a first camera configured to be mounted on a front side of the helmet unit,
a second camera configured to be mounted on a rear side of the helmet unit,
a third camera configured to be mounted on a right side of the helmet unit, and
a fourth camera configured to be mounted on a left side of the helmet unit.

6. The helmet according to claim 1, wherein the camera unit includes a stereoscopic camera for displaying a recorded video in three-dimensional form.

7. The helmet according to claim 1, wherein
a lens portion of the camera unit is only exposed or projected to the outside while the other portions are embedded in the helmet unit, and
at least a part of the encoding unit, the communication unit, and the synchronizing unit is embedded in the helmet unit.

8. A method of recording a multi-angle video by a helmet for recording the multi-angle video, the method comprising:
transmitting, by each of a plurality of helmets for recording videos of different angles at different locations from each other, device information to a server;
determining, by the server, whether or not each of the helmets belongs to a predetermined recording group based on the device information;
transmitting, by the server, synchronization information and a control signal to a helmet that is determined to belong to the recording group;
recording, by each of the helmets, a video of outside;
encoding, by each of the helmets, the video into a digital video;
generating, by each of the helmets, marking information by performing a marking on the video according to a predetermined period based on the synchronization information; and
transmitting, by each of the helmets, the encoded video and the marking information to the server.

9. The method according to claim 8, wherein the synchronization information includes information on whether or not the helmet performs a marking on the recorded video.

10. The method according to claim 8, wherein the transmitting the encoded video and the marking information includes
storing the encoded video and the marking information in a storage unit of the helmet, and
transmitting the encoded video and the marking information to the server.

11. The method according to claim 8, wherein the determining includes
determining, when the device information of the helmet is registered in the server with the same group name, that the helmet belongs to the recording group, and
updating, when information on the helmet and device information stored in the server shows a difference, the stored device information.

12. The method according to claim 8, wherein the transmitting synchronization information and a control signal includes
transmitting the synchronization information to a helmet that is determined to belong to the recording group,
determining whether or not the helmets to which the synchronization information has been transmitted are ready to record the video,
transmitting, when the helmets are ready to record the video, the control signal including a recording start signal to the helmets, and
receiving an acknowledgement signal from a helmet that has received the recording start signal.

13. The method according to claim 8, wherein the generating includes transmitting, by the helmet, the marking information generated by performing the marking according to the predetermined period based on information received from the server to the server.

14. The method according to claim 8, wherein the generating includes
storing the marking information according to the predetermined period based on information received from the server in a storage unit of the helmet, and
transmitting, when the encoding is completed, the encoded video and the marking information stored until the encoding is completed to the server.

15. The method according to claim 8, wherein the determining includes
determining, when the device information of the helmet is not registered in the server with the same group name, that the helmet does not belong to the recording group,
generating a group for the helmet that does not belong to the recording group based on the device information of the helmet and setting the helmet as a master recording device,
generating a group table for the generated group, and
storing information on a synchronization period among pieces of information on the master recording device in the group table.

16. The method according to claim 15, further comprising:
transmitting, by the server, when a group-information request signal is transmitted from a helmet that does not belong to the recording group to the server, information on the generated group to the helmet that has transmitted the group-information request signal;
receiving an admission request signal from the helmet to which the information on the generated group has been transmitted;
receiving a permission signal for the helmet from the master recording device;
including, upon receiving the permission signal, the helmet from which the admission request signal has been transmitted in the generated group as a slave recording device; and
synchronizing a digital video recorded by the master recording device and a digital video recorded by the slave recording device based on marking information generated according to a specific period corresponding to the generated group.

17. The method according to claim 16, further comprising transmitting, by the server, upon receiving a synchronization completion signal from the master recording device, the synchronization completion signal to the slave recording device.
